(19) United States
(12) Patent Application Publication
(10) Pub. No.: US 2026/0298124 A1
(43) Pub. Date: Oct. 1, 2026

(54) ULTRA-LOW NOX DIESEL ENGINE GENERATOR WITH SELECTIVE CATALYTIC REDUCTION ENGINEERED EXHAUST SYSTEM AND METHOD

(71) Applicant: Industrial Service Solutions WC, Inc., Houston, TX (US)

(72) Inventors: Paul F. Rembach, Cypress, TX (US); Wade Stockstill, Houston, TX (US); Tarik Gharrafi, Dubai (AE); Jared Michael Oehring, Houston, TX (US)

(73) Assignee: Industrial Service Solutions WC, Inc., Houston, TX (US)

(21) Appl. No.: 19/461,590

(22) Filed: Jan. 27, 2026

Related U.S. Application Data
(60) Provisional application No. 63/749,835, filed on Jan. 27, 2025.

(51) Int. Cl. F01N 3/20; F01N 11/00

(52) U.S. Cl. CPC F01N 3/208; F01N 3/2006; F01N 3/2066; F01N 11/00; F01N 2550/05; F01N 2590/10; F01N 2610/02; F01N 2610/1453; F01N 2900/08

(57) ABSTRACT

A selective catalytic reduction (SCR) system for a diesel generator platform includes an SCR reactor having a catalyst and an exhaust inlet, the SCR reactor configured to receive diesel engine exhaust gas and convert nitrogen oxides (NOx) in the presence of an ammonia-based reductant. The SCR system further includes an injector upstream of the SCR reactor configured to meter the reductant into the exhaust gas and one or more sensors for upstream NOx, downstream NOx, catalyst temperature, exhaust temperature, exhaust flow, differential pressure, reductant flow, or reductant pressure. The SCR system also includes a controller configured to enable dosing of the reductant within a temperature band based on sensor signals, regulate an NH3/NOx ratio based on sensor signals, and adjust dosing of the reductant responsive to generator load signals to anticipate flow changes of the exhaust gas.

### CROSS-REFERENCE TO RELATED APPLICATION(S)

This application is related to and claims the benefit of priority from U.S. Provisional Application N. 63/749,835, titled “SCR for Diesel Generator,” filed on Jan. 27, 2025, the full disclosure of which is hereby incorporated by reference in its entirety for all purposes.

### BACKGROUND

### 1. Field of Disclosure

Embodiments of the present disclosure relate to systems and methods for diesel engine-driven generators configured to provide power to loads such as utility, data centers, hospitals, and universities. In particular, embodiments of the present disclosure relate to diesel generators that reduce oxides of nitrogen (NOx) emissions via an exhaust gas recirculation (EGR) engine combined with selective catalytic reduction (SCR) using an ammonia-based reductant.

### 2. Description of Related Art

Diesel generator sets are widely deployed for prime power, standby power, islanded microgrids, and other mission-critical loads, and must comply with stringent emissions requirements such as U.S. EPA Tier 4 Final. In many commercial offerings, NOx control is achieved by exhaust aftertreatment using selective catalytic reduction (SCR) and/or by strategies such as exhaust gas recirculation (EGR). Natural-gas-fueled engines can achieve comparatively lower NOx emissions, but they are often less responsive to rapid load changes and natural gas is a lower energy density fuel, which can complicate logistics.

Presently, Tier 4 Final compliant diesel generators are commonly powered by EPA Tier 2compliant diesel engines with the addition of an SCR engineered exhaust. The SCR engineered exhaust typically uses urea as the reductant and is required to meet the Tier 4 Final exhaust gas emission requirements for their EPA Tier 2 compliant diesel engines.

Urea-based SCR arrangements, however, present several practical and technical drawbacks. Urea has a relatively short usable life, is treated as a hazardous material, and has faced periods of limited availability and price spikes. Moreover, if an SCR dosing fault occurs, the underlying engine reverts to its baseline tier (e.g., Tier 2), forcing the unit to be taken offline to avoid emissions noncompliance. Additionally, the engineered exhaust needed for a Tier 2 diesel engine to comply with EPA Tier 4 Final specifications often adds exhaust backpressure near the limits allowed for the engine to operate efficiently. Exceeding these limits may require derating the engine's maximum allowable power output.

While natural-gas generator sets are often selected to achieve low NOx, this approach can strain gas-supply infrastructure. Growing dependence on pipeline gas for generation has created volumetric stress and logistical delays for capacity expansion, with knock-on schedule and cost impacts in regions where additional gas delivery is not readily available. These constraints underscore the need for alternatives that address NOx without incurring the supply-chain, operability, and backpressure limitations associated with conventional urea-SCR implementations.

### SUMMARY

Applicant recognized the problems noted above herein and conceived and developed embodiments of diesel engine generator systems with SCR subsystems and SCR control methods, according to the present disclosure, that reduce NOx emissions below Tier 4 Final levels.

In an embodiment, an SCR system for a diesel generator platform includes an SCR reactor comprising a catalyst and an exhaust inlet, and the SCR reactor is configured to receive engine exhaust gas comprising nitrogen oxides (NOx) and convert NOx to nitrogen and water in the presence of a reductant. The SCR system also includes an injector upstream of the SCR reactor configured to meter the reductant into the exhaust gas, and the reductant is an ammonia-based reductant. Additionally, the SCR system includes one or more sensors including sensor signals of upstream NOx, downstream NOx, catalyst temperature, exhaust temperature, exhaust flow, differential pressure, reductant flow, and/or reductant pressure. The SCR system further includes a controller coupled to the one or more sensors and the injector, and the controller is configured to enable dosing of the reductant within a temperature band based on sensor signals, regulate an NH3/NOx ratio based on the sensor signals, and adjust dosing of the reductant responsive to generator load signals to anticipate flow changes of the exhaust gas.

In another embodiment, a power generation system includes a diesel engine, an engine-mounted electronic control unit configured to govern the diesel engine, an electrical generator mechanically coupled to the diesel engine, an SCR subsystem, and an integrated controls and switchgear assembly that coordinates with the engine-mounted electronic control unit and the SCR subsystem. The SCR subsystem of the power generation system includes an SCR reactor comprising a catalyst and an exhaust inlet, and the SCR reactor is configured to receive exhaust gas from the diesel engine comprising nitrogen oxides (NOx) and convert NOx to nitrogen and water in the presence of a reductant. The SCR subsystem of the power generation system further includes an injector upstream of the SCR reactor configured to meter the reductant into the exhaust gas and one or more sensors including sensor signals of upstream NOx, downstream NOx, catalyst temperature, exhaust temperature, exhaust flow, differential pressure, reductant flow, and/or reductant pressure. Additionally, the SCR subsystem of the power generation system includes a controller coupled to the one or more sensors and the injector, and the controller is configured to enable dosing of the reductant within a temperature band based on the sensor signals.

In another embodiment, a method of controlling an SCR system that has an SCR reactor, a catalyst, and a reductant. The method includes acquiring sensor signals of upstream NOx, downstream NOx, catalyst temperature, exhaust temperature, exhaust flow, differential pressure, reductant flow, and/or reductant pressure. The method also includes receiving a load-related signal indicative of generator real-power or a kW-command from a generator supervisory controller, enabling reductant dosing in a temperature band conducive to NOx conversion, and generating a dosing command for the reductant based on the sensor signals. Additionally, the method includes metering and injecting, responsive to the dosing command, the reductant into engine exhaust upstream of the catalyst to convert NOx in the SCR reactor. The method further includes controlling an NH₃/NOx ratio toward a near-stoichiometric value to achieve NOx conversion efficiency and minimizing ammonia slip under steady-state and transient loading.

### BRIEF DESCRIPTION OF DRAWINGS

The present technology will be better understood on reading the following detailed description of non-limiting embodiments thereof, and on examining the accompanying drawings, in which:

FIG. 1 is a side view of an ultra-low NOx power generation system that includes a Tier-4-Final-compliant diesel engine with an SCR engineered exhaust subsystem, in accordance with embodiments of the present disclosure;

FIG. 2 is a top view of an ultra-low NOx power generation system that includes a Tier-4-Final-compliant diesel engine with an SCR engineered exhaust subsystem, in accordance with embodiments of the present disclosure;

FIG. 3 is a control block diagram for the operation of an ultra-low NOx power generation system, in accordance with embodiments of the present disclosure;

FIG. 4 is a flow chart of a method for controlling an SCR system for a diesel generator platform, in accordance with embodiments of the present disclosure;

FIG. 5 is a side view of an SCR system used in conjunction with a diesel generator set, in accordance with embodiments of the present disclosure;

FIG. 6 is a top view of an SCR system used in conjunction with a diesel generator set, in accordance with embodiments of the present disclosure;

FIG. 7 is a side view of an ultra-low NOx power generation system with external coolers and an external fuel tank, in accordance with embodiments of the present disclosure;

FIG. 8 is a side view of a generator set depicting a mechanical coupling between a diesel engine and a generator, in accordance with embodiments of the present disclosure;

FIGS. 9A-9C present tables of pre-injection and post-injection averages of exhaust chemicals outputted from embodiments of systems discussed herein, in accordance with embodiments of the present disclosure; and

FIG. 10 presents tables of particulate matter mass concentrations and mass emission rates resulting from embodiments of systems discussed herein, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/−10 percent.

Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Embodiments of the present disclosure generally relate to ultra-low NOx (ULN) diesel generator systems that may pair (i) a diesel engine platform already compliant with Tier-4-Final emissions limits without selective catalytic reduction (SCR), with (ii) an engineered SCR exhaust subsystem supplied with an ammonia-based reductant. As used herein, “NOx” may refer to oxides of nitrogen including NO and NO₂, and “reductant” may refer to ammonia or ammonia precursors that are delivered into the exhaust stream. Embodiments discussed herein may further integrate thermal monitoring, reductant-dosing control, ammonia-containment features, and generator/power-management coordination to deliver ULN levels. Systems described herein may be single unit or parallel multi-unit plants; in addition, controls for the systems may be centralized or distributed.

In various embodiments, the generator platform may be a high-output, multi-megawatt diesel unit (e.g., on the order of about 3-3.15 MW at 60 Hz). In at least one embodiment, the diesel unit may be installed within an integrated enclosure that also houses switchgear, protection, automation, and communications interfaces suitable for grid parallel, islanded, or standby service. The prime mover may be a Tier-4-Final-compliant engine that may achieves its baseline emissions levels without exhaust-injected catalyst, for example, an EGR-equipped platform, which may then be coupled to the disclosed SCR subsystem to further reduce NOx to ULN levels while preserving the diesel system's responsiveness and energy density. Exhaust from the engine may be routed to an SCR reactor in the SCR subsystem containing one or more catalyst layers, and an upstream metering and injection unit may introduce the reductant under closed-loop control so that the system meets the targeted post-treatment emissions levels. In embodiments of the SCR subsystem, the SCR subsystem may be configured to receive engine exhaust and convert NOx to nitrogen and water in the presence of a catalyst while coordinated controls regulate injection of the reductant to achieve high conversion efficiency with minimized ammonia slip under steady-state and transient loading.

The reductant may be an aqueous ammonia solution; in some embodiments, a solution of about 10% ammonia in water may be employed, while other embodiments utilize about 19% aqueous ammonia, and further variants may select concentrations within a range (for example, about 5-30% by weight) to balance reactivity, storage, and safety objectives. In various embodiments, injection may be coordinated with exhaust and/or catalyst temperature so that dosing is enabled only when the SCR operates within a defined thermal band conducive to efficient conversion and reduced slip. As such, in at least one embodiment, reductant dosing may be disabled during warm-up or off-spec conditions. Sensor inputs integrated within embodiments may include one or more of: upstream and downstream NOx, exhaust temperature, exhaust flow, differential pressure across the reactor, and reductant flow or pressure. In some embodiments, control logic may modulate the NH₃/NOx ratio toward a desired value near stoichiometric with safety margins to accommodate dynamic load changes.

In some implementations, the SCR controller may communicate with the engine control unit and the generator supervisory system to align dosing with load, inhibit injection during start/stop sequences or fault conditions, and/or present alarm or status signals to a power-management system that coordinates multiple sources. To improve transient performance, certain embodiments may apply a NOx-integrator strategy in which a generator kW-command signal is combined with a NOx-error signal to overcome control-loop propagation delays and PID hysteresis, thereby producing near-instantaneous adjustment of reductant injection volume as exhaust flow changes with load. The KW command signal is the same signal used to sum the diesel engine speed error signal thus limiting RPM droop of the engine. When summed with the NOx error signal injection of the atomized aquas ammonia reductant is optimized resulting reduced fluctuations in the NOx levels of the exhaust during changes in load. If the aftertreatment subsystem is disabled for any reason, the unit may continue operating at the base engine's Tier-4-Final exhaust level as a defined fallback mode, thus maintaining availability while alerting as to the changed emissions state.

Because ammonia handling requires specific precautions, in various embodiments, the system may include dedicated containment within a compartment, ventilation and/or purge control, leak detection (e.g., of ammonia), interlocks that disable dosing upon detected faults, and/or emergency-stop logic that isolates the reductant supply. All or some of the aforementioned precautionary equipment and procedures may be integrated within an enclosure architecture suited for stationary generator deployment. In embodiments, the enclosure may be configured with separate rooms (for example, engine/generator, switchgear/controls, and cooling), structural provisions to support the SCR unit and exhaust silencer, and ancillary systems such as interior/exterior lighting and climate control for electrical equipment, while fire detection and suppression, fuel storage and conditioning, and access for maintenance are integrated into a master skid and removable enclosure. In some embodiments, the SCR subsystem may include a maintenance mode that allows safe servicing of the SCR subsystem while the generator remains online, during which the system reverts to the base engine emissions level (e.g., EPA Tier 4 Final) until aftertreatment is restored to normal operation.

As used herein, ULN levels may be characterized by representative values around about 11 parts per million by volume, dry (ppmvd) at 15% O₂, about 21 ppmvd, or approximately 0.15 g/kW-hr, reflecting substantial reduction relative to engine-only operation, while maintaining diesel-generator responsiveness and fuel-handling advantages. The ULN diesel generator with SCR exhaust may exhibit a 98.2% overall reduction from traditional diesel Tier 4 EGR system or Tier 4 SCR system alone. In some embodiments, NOx levels from the diesel generator and SCR system may be comparable to or lower than natural-gas generator sets of similar output. In certain tests of the performance of the diesel engine with the SCR subsystem, laboratory testing has documented NOx and particulate matter levels meeting or surpassing prospective Tier-5-type targets at load conditions such as 10%, 50%, and 100% load.

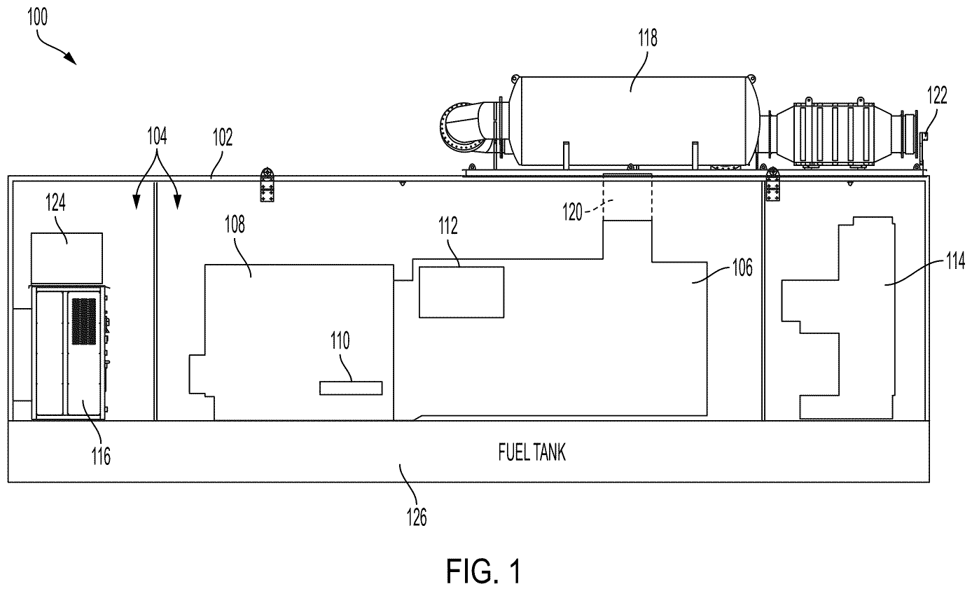

FIG. 1 is a side view of an ultra-low NOx power generation system 100 (e.g., the ULN power generation system 100, the power generation system 100, or the system 100). The power generation system 100 may include an enclosure 102 that houses various equipment, parts, or aspects of the system 100. Further, the enclosure 102 may comprise one or more rooms 104, with different dedicated equipment in different dedicated rooms 104. The one or more rooms 104 of the enclosure 102 may provide some level of separation in terms of heat, exhaust/fumes, or potential leaks produced from various types of equipment incorporated in the system 100. The enclosure 102 may be a removable enclosure bolted to master skid. Furthermore, the enclosure 102 may provide structural framing for SCR unit/silencer/exhaust, separate rooms, louvers, fans, climate control, lighting, and/or emergency egress hardware.

The system 100 includes a diesel engine 106 (e.g., an engine 106) as the prime mover, which, in some embodiments, may be a Tier-4-Final-compliant diesel engine 106. Specifically, in at least one embodiment, the engine 106 is a Wabtec Corporation 12V250SDC Tier 4 emissions compliant diesel engine. The engine 106 may use ASTM D-975 low sulphur diesel as the BTU source of energy. However, it should be appreciated that the engine 106 may be a non-Tier-4-Final-compliant engine, may be an engine manufactured by another company, or may run on other types of diesel. The system 100 may also include an electrical generator 108 directly mechanically coupled to an output shaft (not depicted in FIG. 1) of the engine 106 such that rotational power produced by the engine 106 is directly transferred to a rotor assembly (also not depicted in FIG. 1) of the generator 108. As the engine 106 drives the rotor assembly of the generator 108, a magnetic field is induced, which ultimately produces three-phase alternating current electrical power suitable for distribution to facility loads or grid-connected equipment.

The generator 108 may include an electric starter 110, which may be configured to supply battery-powered cranking torque to the diesel engine 106, thereby initiating rotation of the engine 106 until combustion of diesel within the engine 106 becomes self-sustaining. Further, the diesel engine 106 may include an engine-mounted electronic control unit 112 (e.g., ECU 112, engine ECU 112, control unit 112, engine controller 112, or controller 112), which may govern the diesel engine's fuel and speed, manage start/idle/run transitions, monitor sensor inputs (coolant, oil, temperature/pressure, etc.), and/or enforce engine-level permissives and trips such as overspeed. In at least one embodiment, the engine 106, the generator 108, the electric starter 110, and the controller 112 may all be housed in a single room 104 of the enclosure 102.

The system 100 may further include a diesel radiator 114 (e.g., radiator 114). The diesel radiator 114 may be a vertical cooling module that includes jacket water and aftercooler cores and provides cooling using a variable-frequency, inverter-driven fan. Sensors of the radiator 114 may include temperature, flow, pressure, and valve-position sensing, and the radiator 114 may have closable intake and exhaust louvers. In at least one embodiment, the radiator 114 is housed in a dedicated room 104 within the enclosure 102. In some embodiments, the radiator 114 is housed in a separate room 104 from the engine 106 and generator 108.

The power generation system 100 may further include an integrated controls and switchgear assembly 116 (e.g., switchgear assembly 116 or assembly 116), which may generally manage power distribution, protection, and metering. More particularly, the switchgear assembly 116 may include generator switchgear with breaker protection and permissive interlocks, load-sharing/synchronizing and voltage-regulation controllers, Human Machine Interface (HMI) screens, ground detection, and redundant 24 VDC control power for local or automatic (PMS) operation. The assembly 116 may coordinate with the engine-mounted ECU 112 and an SCR subsystem 118 (e.g., for dosing permissives and alarms) so that electrical operations, synchronization, and emissions management function in an integrated manner across the ULN power generation system 100. The integrated controls and switchgear assembly 116 may be housed in a dedicated, climate-controlled room 104 of the enclosure 102. In at least one embodiment the switchgear assembly 116 is housed in a separate room 104 from both: the dedicated room 104 for the engine 106 and generator 108; and the dedicated room for the cooling/radiator 114.

The SCR subsystem 118 of the system may function to remove NOx from engine exhaust in a chemical exchange process in a reactor. The catalyst in the reactor of the SCR subsystem 118 may be monolith, plate, or other geometries of catalyst. The SCR subsystem 118 may receive exhaust from the engine 106 through an exhaust inlet 120 positioned between the engine 106 and the SCR subsystem 118, the exhaust inlet 120 fluidly connecting the exhaust from the engine 106 with the SCR subsystem 118. In other words, the SCR subsystem 118 may be in fluid communication with the engine 106 and configured to receive exhaust gas through the exhaust inlet 120 that is discharged from the engine 106. In some embodiments, the exhaust from the engine 106 may already be Tier 4 certified exhaust.

After the exhaust gas undergoes the chemical exchange process in the SCR subsystem 118, the system 100 may produce an ultra-low NOx (ULN), low particulate matter exhaust output 122 (e.g., at the exhaust outlet 122). Thus, the SCR subsystem 118 may further remove NOx from the already Tier 4 certified exhaust, lowering NOx levels to below Tier 4 certified levels in the exhaust output 122. The resulting exhaust gas in the exhaust output 122 may contain levels of NOx and other contaminates that are equal to or less than the exhaust contaminates from a natural gas generator system, while the diesel engine and generator 106, 108 is still able to displace an equivalent power level to a natural gas generator system.

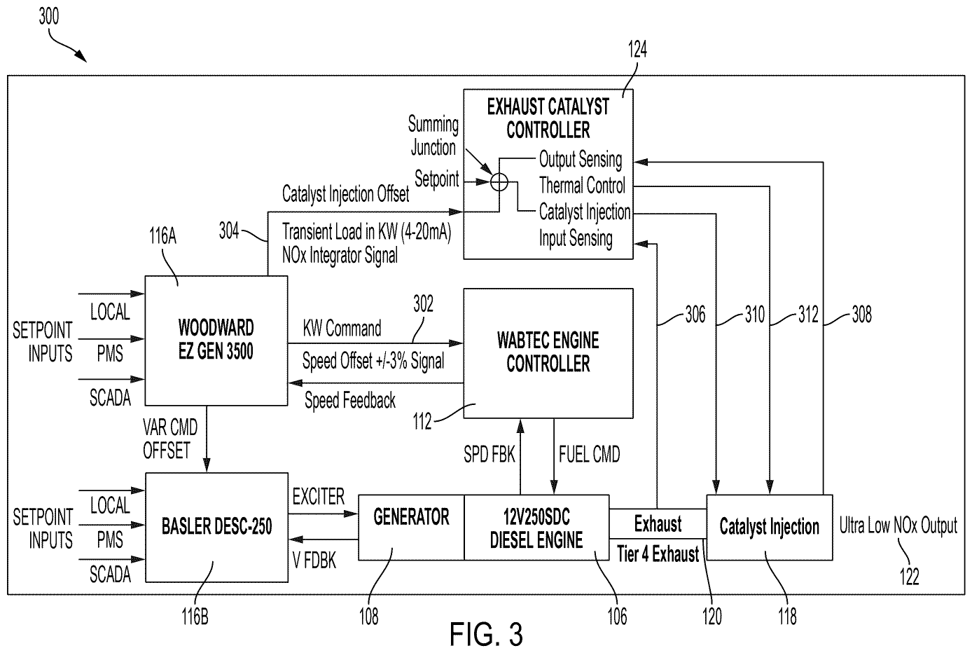

The system 100 may further include an SCR controller 124 integrated with the engine ECU 112 and generator/switchgear controls 116 to monitor and control the ammonia-based aftertreatment in the SCR subsystem 118 as part of the exhaust path. The SCR controller 124 may interface with exhaust-stream instrumentation (such as upstream/downstream NOx sensors, exhaust temperature, and flow sensors), a reductant tank in the SCR subsystem 118, and a metering pump and injector upstream of the SCR subsystem 118. The SCR controller 124 may operate by enabling and controlling reductant dosing within a defined temperature band to achieve ultra-low NOx levels that may be below Tier 4 Final. More details regarding the SCR controller 124 and SCR subsystem 118 are described in reference to FIG. 3.

Additionally, The power generation system 100 may include a fuel system 126 having a fuel tank configured to store the energy source of the system 100. The fuel system 126 may be integrated with a base skid of the enclosure 102 and may provide capacity for extended operation (e.g., 36 hours at 100% load). To provide the fuel to the engine 106 from the fuel tank of the fuel system 126, the fuel system 126 may include suction and return lines, isolation valves, and/or transfer pumps. Further integrated with the fuel system 126 may be sensors for pressure, flow, and fuel level, and the fuel system may include filtration and centrifuge fuel cleaning systems. Other systems incorporated into the system 100 may be a fire detection and suppression systems that may be within the enclosure 102. In some embodiments, the fire detection and suppression systems may include thermal and ionization sensors, monitoring and remote activation capability, and/or suppression tanks and valves.

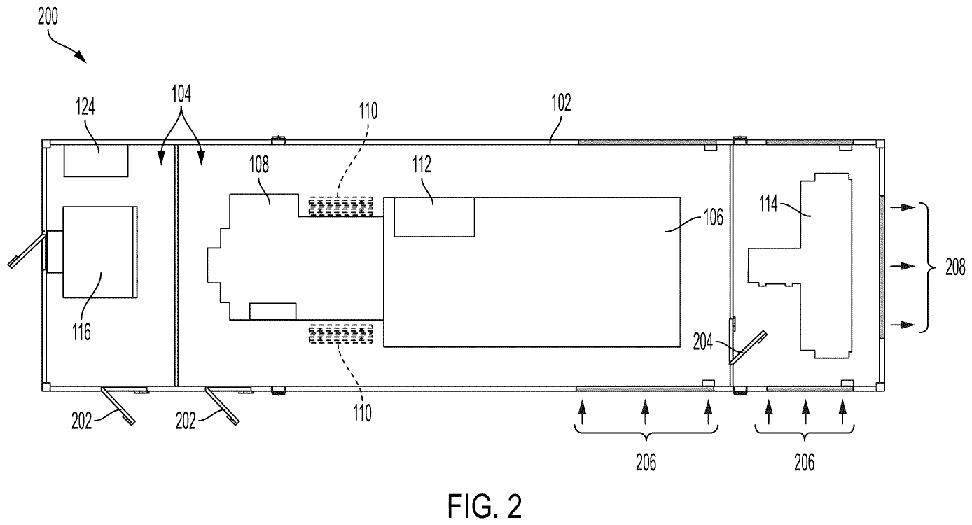

FIG. 2 is a top view of an ultra-low NOx power generation system 200 (e.g., the ULN power generation system 200, the power generation system 200, or the system 200). The power generation system 200 shown in the top view of FIG. 2 shows many similar components and equipment of the power generation system 100 that could be seen in the side view of FIG. 1. For example, the system 200 includes the enclosure 102 including the one or more rooms 104. In one room 104, the system 200 includes the diesel engine 106, the electrical generator 108 mechanically coupled to the engine 106, the electric starter 110, and the engine ECU 112. In a second room 104, FIG. 2 depicts that the system 200 includes the radiator 114 to provide cooling to the system 200. In a third room 104, the system 200 includes the integrated controls and switchgear assembly 116 and the SCR controller 124.

Further illustrated in FIG. 2, the system 200 may include one or more exterior doors or panels 202, which may be integrated into the enclosure 102 to allow servicing personnel to access the rooms 104 of the system 200 from the outside through the exterior doors 202. Additionally, the enclosure 102 may include one or more interior doors or panels 204 to allow for access between rooms 104 within the enclosure 102.

Moreover, the system 200 may include one or more air inlets 206 and one or more air outlets 208 integrated into the enclosure 102. In an embodiment, the room 104 housing the engine 106 includes air inlets 206 to supply the engine 106 with air for the combustion of diesel. The air inlets 206 may allow for high-volume cooling and ventilation flow. One of the air inlets 206 may also allow cool air to move across the radiator 114. The one or more air outlets 208 may allow for hot air, such as from the radiator 114, to escape the enclosure 102 to be replaced by cooler air. The air inlets 206 and air outlets 208 may support safe operation of adjacent rooms 104 by providing purge/ventilation capacity and monitored airflow/temperature to prevent heat build-up or hazardous accumulations within the enclosure 102.

FIG. 3 is a control block diagram 300 for the operation of an ultra-low NOx power generation system. The control block diagram 300 includes many similar components and equipment of the power generation system 100 of FIG. 1 and power generation system 200 of FIG. 2. For example, blocks in the diagram representing the diesel engine 106, the generator 108, the engine controller 112, the integrated controls and switchgear assembly 116, the SCR subsystem 118, the exhaust inlet 120, the exhaust output 122, and the SCR controller 124 are shown.

In the embodiment illustrated in FIG. 3, the diesel engine 106 is mechanically coupled to the synchronous generator 108. The engine 106 may be governed by a dedicated engine controller 112. Within the controls and switchgear assembly 116, a Woodward EZ Gen 3500 controller 116A may coordinate real-power dispatch and speed/isochronous control in the system, while the Basler DESC-250 Automatic Voltage Regulator 116B (e.g., AVR 116B) may regulate excitation (reactive power and terminal voltage). As depicted in FIG. 3, the engine's lean-NOx exhaust (e.g., Tier 4 compliant) is routed through the exhaust inlet 120 to the SCR subsystem 118 controlled by the SCR controller, which may implement selective catalytic reduction using aqueous ammonia to achieve ultra-low NOx emissions at the exhaust outlet 122. In at least one embodiment, the engine 106 operates at 900 rpm and the generator 108 is rated 3.15 MW/4.0 MVA.

In the embodiment illustrated in FIG. 3, the prime mover in the system is a Wabtec 12V250SDC V12, turbocharged and intercooled, compression-ignition diesel engine that, without further SCR aftertreatment, conforms with EPA Tier 4 and IMO III. In various embodiments, sensors associated with the engine 106 provide speed feedback (“SPD FBK”) and other operating telemetry to the engine controller 112 for closed-loop fueling control (“FUEL CMD”). The engine 106 may deliver mechanical power to the generator 108, and, in at least one embodiment, the generator 108 is a brushless, 8-pole, 60 Hz alternator with AVR-regulated field excitation. Output from the AVR 116B may go to the rotating exciter (via “EXCITER”) in the generator 108, and there may be terminal voltage feedback (“V FDBK”) to the AVR 116B to maintain terminal voltage. The AVR 116B may implement automatic voltage regulation and reactive-power setpoint tracking, it also may accept a VAR command offset (“VAR CMD OFFSET”) from the Woodward controller 116A to coordinate power factor and voltage profile on the generator switchgear (main AC bus).

The Woodward controller 116A may receive setpoint inputs selectable from LOCAL, PMS (Power Management System), or Supervisory Control and Data Acquisition (SCADA) sources. From these inputs and measured system conditions, the controller 116A may issue a kW command speed offset signal 302 (kW command and a fine speed-offset of ±3%) to the engine controller 112, and, as mentioned herein, the controller 116A may forward a VAR command offset to the AVR 116B. The Woodward controller 116A may also exchange speed feedback with the engine controller 112 to support isochronous or droop modes, load sharing, and synchronization.

As mentioned herein, the 12V250SDC engine 106 produces Tier-4 compliant exhaust without relying on an upstream catalyst. Because of this, a downstream SCR subsystem 118 can be sized for very low NOx without imposing a prohibitive derate on the engine 106, and there may be minimal baseline backpressure. The exhaust gas stream therefore may enter the catalyst injection section of the SCR subsystem 118, through the exhaust inlet 120, as a well-conditioned feed gas for final NOx reduction to levels below Tier 4.

The SCR controller 124 of the system may aggregate multiple inputs at a summing junction to compute a commanded catalyst-injection rate and to supervise thermal control of the reactor hardware. SCR controller inputs 304, that is, from the Woodward controller 116A to the SCR controller 124, may include: (i) a NOx integrator signal derived from downstream sensing; (ii) a transient load feed-forward signal proportional to real-power change (e.g., a 4-20 mA signal representing kW); and/or (iii) a catalyst-injection offset for calibration. As mentioned herein, the NOx-integrator strategy may inlcude a generator kW-command signal combined with a NOx-error signal to overcome control-loop propagation delays and PID hysteresis, thereby producing near-instantaneous adjustment of reductant injection volume as exhaust flow changes with load. The KW command signal may be the same signal used to sum the diesel engine speed error signal, thus limiting RPM droop of the engine. When summed with the NOx error signal, injection of the atomized aquas ammonia reductant may be optimized, resulting in reduced fluctuations in the NOx levels of the exhaust during changes in load. Regarding the SCR feed-forward, the Woodward controller 116A may publish a transient load signal to the SCR controller 124. This anticipatory term may pre-emptively scale the dosing command during ramps and step changes occurring within the system, thereby reducing NOx excursions before the integrator path responds.

Other inputs to the SCR controller 124 may include input sensing, which is the engine exhaust sensor feedback 306 (e.g., NOx levels in the Tier 4 Final exhaust leaving the engine 106), and output sensing, which is SCR exhaust output sensor feedback 308 (e.g., NOx levels in the ultimate exhaust output 122 leaving the SCR subsystem 118). SCR exhaust output sensor feedback 308 may also include a sensor feedback measuring ammonia slip in the exhaust output 122. In some embodiments, the system is operated with a target efficiency such as approximately 95% (e.g., a slip rate of 95% would mean the system is 95% efficient).

Furthermore, the SCR controller 124 may drive catalyst injection via an ammonia pressurized feed 310 to the SCR subsystem 118 through atomizing injectors. The SCR controller 124 may also be configured to provide thermal control outputs 312 to heating elements in the SCR subsystem 118, which may function to hold the SCR within its effective temperature window. Sensor feedback to the SCR controller 124 may further include catalyst temperature, as it may be preferable to the temperature of the catalyst to stay within a defined temperature range, so the SCR controller 124, via thermal control, may control heating elements to maintain a certain catalyst temperature.

In one or more embodiments, the reductant used in the SCR may be aqueous ammonia (e.g., a ~19 wt % NH₃ solution), and the reductant may be metered to the exhaust gas in the SCR subsystem 118 via, for example, atomizing injectors. The dosing capacity and line heaters within the SCR subsystem 118 may be sized to maintain delivery across the engine's operating envelope. For example, ammonia dosing hardware may be sized to deliver the required flow rate of reductant over the engine's full operating range (e.g., based on the exhaust flow rate), and/or the equipment associated with the SCR subsystem 118 that provides line-heating/heat-tracing may be sized so the reductant can actually be delivered (i.e., pumped and injected) whenever dosing is enabled by the control logic in the SCR controller 124. Moreover, the SCR controller 124 may be configured to limit the NH₃/NOx ratio to avoid ammonia slip while sustaining conversion during load transients. The SCR subsystem 118 may also include staged heating of exhaust gas so that the SCR reaction occurs in the intended temperature band during, for example, startup and load steps. As temperature rises, the SCR controller 124 may relax preheating while continuing to supervise conversion efficiency and ammonia slip limits. With closed-loop dosing and thermal control by the SCR controller 124 in the SCR subsystem 118, the gas in the exhaust outlet 122 may have NOx levels as low as about 11 ppmvd at 15% O₂ (~0.15 g/kW-hr) under full-load conditions, which may represent reductions of approximately 90% beyond NOx levels of the engine 106 by itself and meeting or exceeding typical natural-gas generator NOx values of comparable rating.

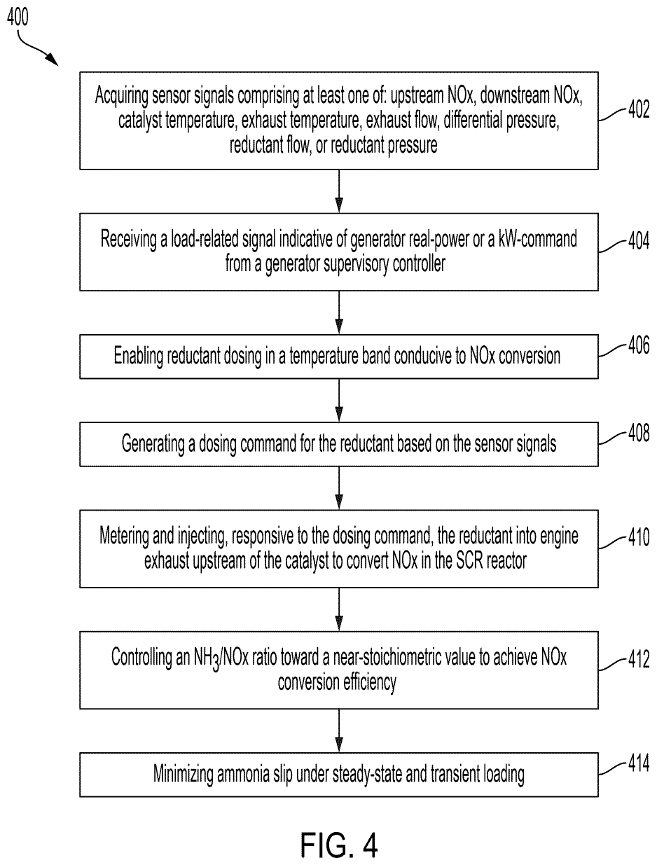

FIG. 4 is a flow chart of a method 400 of controlling a system comprising an SCR reactor, a catalyst, and a reductant. The method 400 may include acquiring sensor signals comprising at least one of: upstream NOx, downstream NOx, catalyst temperature, exhaust temperature, exhaust flow, differential pressure, reductant flow, or reductant pressure 402. The method 400 may further include receiving a load-related signal indicative of generator real-power or a kW-command from a generator supervisory controller 404. Additionally, the method 400 may include enabling reductant dosing in a temperature band conducive to NOx conversion 406, and generating a dosing command for the reductant based on the sensor signals 408. The method 400 may also include metering and injecting, responsive to the dosing command, the reductant into engine exhaust upstream of the catalyst to convert NOx to nitrogen and water in the SCR reactor 410. Furthermore, the method 400 may include controlling an NH₃/NOx ratio toward a near-stoichiometric value to achieve NOx conversion efficiency 412, and minimizing ammonia slip under steady-state and transient loading 414.

In some embodiments, the method 400 may further include inhibiting the injection of the reductant during start or stop sequences or upon detection of a fault condition. In at least one embodiment, the method 400 may also include driving heating elements associated with the SCR reactor to maintain a catalyst temperature within the temperature band. In one or more embodiments, the method 400 may additionally include detecting an ammonia leak, and the method 400 may also include disabling dosing and isolating a reductant supply via emergency-stop logic responsive to the leak detection.

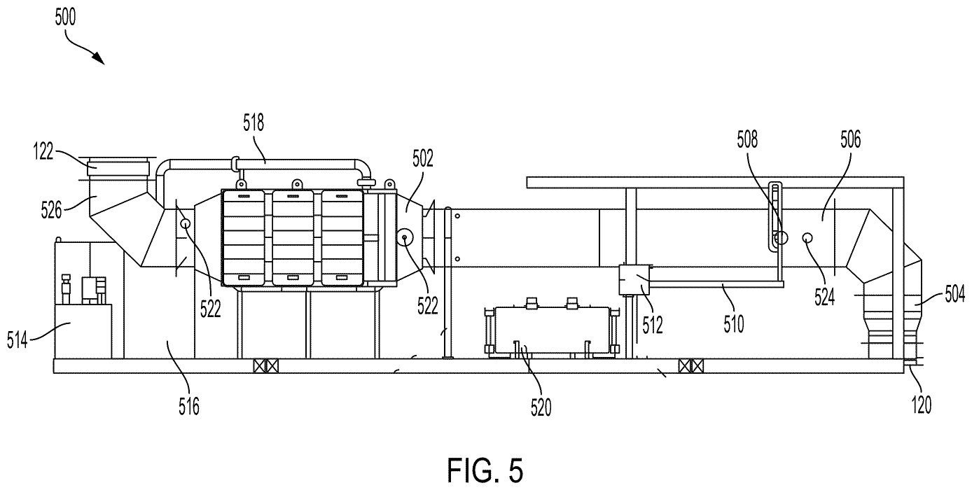

FIG. 5 is a side view of an SCR system 500 that may be used in conjunction with a diesel generator set, as discussed herein. The SCR system 500 may be used in treating exhaust gases from a diesel engine with a reductant in the presence of a catalyst. The SCR system 500 may include a main SCR unit 502, which may house the catalyst used in the SCR reaction. Exhaust gasses from the diesel engine may enter the SCR system 500 via the exhaust inlet 120. At the exhaust inlet, there may be an exhaust inlet sensor 504, which may measure and send sensor signals regarding exhaust inlet gas flow rate, exhaust inlet gas pressure, and/or exhaust inlet gas temperature. The exhaust inlet sensor 504 may also sense NOx concentration of the exhaust inlet gasses. Exhaust gasses from the exhaust inlet 120 may enter a reactant mixing section 506 where exhaust gasses contact the reductant. Reductant may be injected into the reactant mixing section 506 via an injector 508, which may be an atomizing injector. Reductant may reach the injector 508 via a dosing line 510, and the dosing line 510 may run from a doser box 512 to the injector 508. A doser box 512 may be an enclosed module that contains the equipment required to meter the correct amount of reductant, control the injection process (e.g., injection pressure, flow rate, etc.), condition the reductant (e.g., heat it, filter it, monitor it), and/or deliver the reductant to the injector 508 mounted on the reactant mixing section 506. The doser box 512 may be mounted upstream from the SCR unit 502. Reductant (e.g., ammonia) used in the SCR system 500 may be held in a reductant tank 514. From the reductant tank 514, when dosing is commanded, the reductant may flow from the reductant tank 514, to the doser box 512, through the dosing line 510, and to the injector 508 to be injected into the reactant mixing section 506 to contact exhaust gasses.

Further illustrated in FIG. 5 is a heater 516 which may heat a medium (e.g., air) when the SCR unit 502 may need to increase in temperature to maintain SCR reaction temperature with the defined temperature band for an efficient SCR reaction. The heated medium from the heater 516 may pass through a duct 518, and the duct 518 may fluidly connect the heater 516 to the SCR unit 502. Additionally, the system 500 may include a tank associated with an expansion and cooling system 520. The expansion and cooling system 520 which may cool a medium when the SCR unit 502 may need to decrease in temperature to maintain SCR reaction temperature with the defined temperature band for an efficient SCR reaction.

In addition to the exhaust inlet sensor 504, the system 500 may include one or more of various other types of sensors. One or more sensors in the system 500 may collect and send sensor signals of upstream NOx, downstream NOx, catalyst temperature, exhaust temperature, exhaust flow, differential pressure, reductant flow, and/or reductant pressure For example, one or more differential pressure transducers or sensors 522 may be positioned at one or more locations on the SCR unit 502. The differential pressure transducers 522 may measure pressure drop across the SCR unit 502. Additionally, the system 500 may include an oxidation catalyst temperature sensor 524, which may be positioned on the reaction mixing section 506, as depicted in FIG. 5. Moreover, downstream from the SCR unit, once gasses have been treated with reductant and passed through the catalyst, there may be an exhaust outlet sensor 526, which may measure and send sensor signals regarding exhaust outlet gas flow rate, exhaust outlet gas pressure, and/or exhaust outlet gas temperature at an exhaust gas outlet 122. The exhaust outlet sensor 526 may also sense NOx concentration of the exhaust outlet gasses.

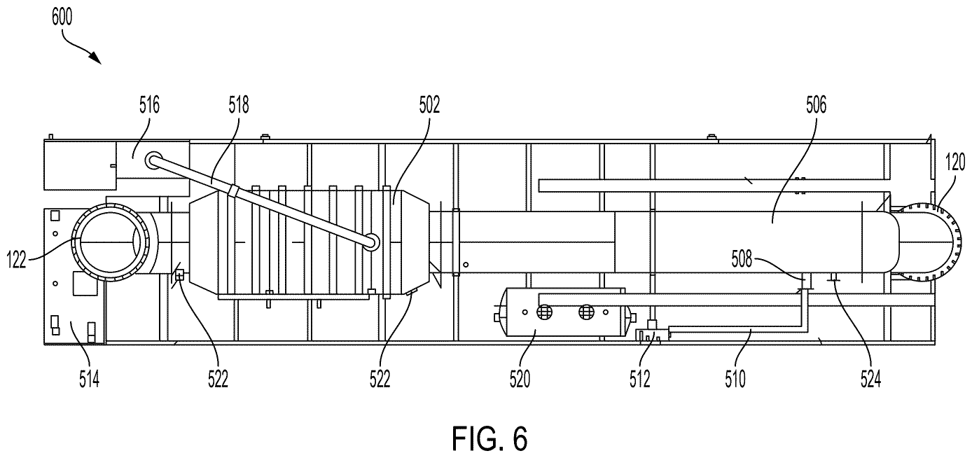

FIG. 6 is top view of an SCR system 600 that may be used in conjunction with a diesel generator set, as discussed herein. The SCR system 600 may include many of the same components as discussed in reference to the SCR system 500 of FIG. 5. For example, as depicted in FIG. 6, the SCR system 600 includes the exhaust inlet 120, exhaust outlet 122, SCR unit 502, reaction mixing section 506, injector 508, dosing line 510, doser box 512, reductant tank 514, heater 516, duct 518, expansion and cooling system 520, differential pressure sensors 522, and oxidation catalyst temperature sensor 524.

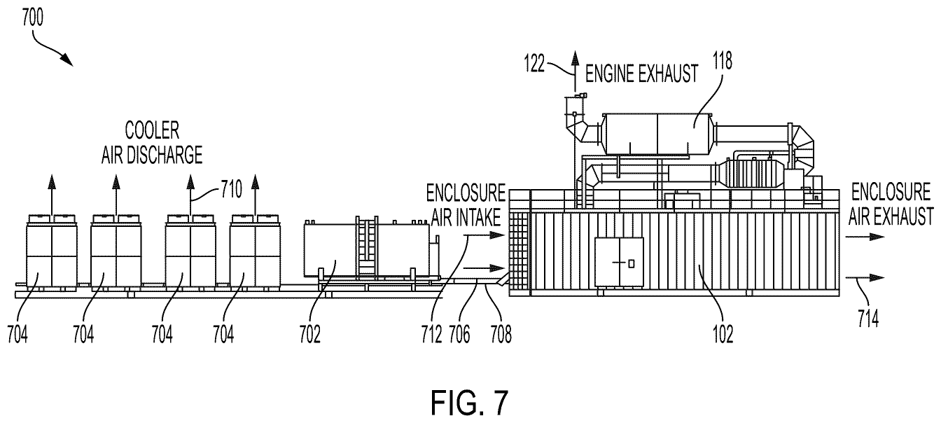

FIG. 7 is a side view of an alternative embodiment of a ultra-low NOx power generation system 700 (e.g., the ULN power generation system 700, the power generation system 700, or the system 700). The power generation system 700 includes many similar features of the power generation systems 100, 200 discussed herein, such as the enclosure 102, SCR subsystem 118, and exhaust output 122. The power generation system 700 may include an external fuel tank 702 positioned outside the enclosure 102. Unlike the fuel tank 126 of the power generation system 100 of FIG. 1, the external fuel tank 702 of FIG. 7 does not sit on the skid of the enclosure to be the base or the bottom of the enclosure 102. Instead, the external fuel tank 702 is disconnected from the enclosure 102 as a separate free-standing tank. Additionally illustrated in FIG. 6 are one or more coolers 704, also which may be positioned external to the enclosure 102. The one or more coolers 704 may receive hot air or hot liquid (e.g., water or coolant) from within the enclosure 102 and provide cooling in order to regulate temperature of the engine and other components associated with the system 700. The external fuel tank 702 may be connected to components within the enclosure 102 via one or more fuel pipes 706 that allows fuel to be pumped or otherwise flow to the engine within the enclosure 102. Similarly, the one or more coolers 704 may be connected to components within the enclosure via one or more cooling pipes 708 to allow air, liquid (e.g. water or coolant), etc. to be pumped or flowed between the one or more coolers 704 and components within the system 700.

Regarding air flow, the one or more coolers may output air discharge 710, which may allow heat to dissipate from the system 700. In at least one embodiment, the one or more coolers 704 may operate similarly to the radiator 114 discussed herein. Additionally, the enclosure 102 may have one or more enclosure air intakes 712 to allow fresh, cooler air to enter the enclosure 102, and the enclosure 102 may have one or more enclosure air outlets 714 to allow warmer air to leave the enclosure 102. The air intakes 712 or the air outlets 714 of the enclosure 102 may be equipped with one or more fans to direct air flow.

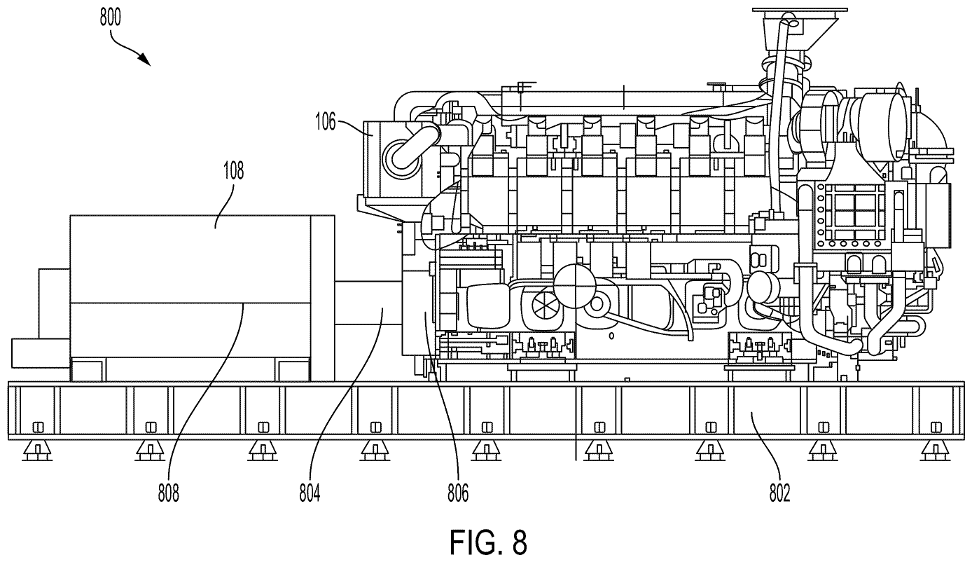

FIG. 8 illustrates a side view of a generator set 800 (e.g., genset 800) incorporated into the power generation systems of the present disclosure. The genset 800 may be secured to a skid 802, and the skid 802 may comprise the base of the enclosure discussed herein. As depicted in FIG. 8, the genset 800 includes the diesel engine 106 and the electrical generator 108, and the genset 800 may include a mechanical coupling 804 between the diesel engine 106 and the generator 108. The mechanical coupling 804 may allow the rotational power from the combustion occurring in the engine 106 to be transferred to the generator 108 so that electrical power can be produced in the generator 108. The mechanical coupling 804 may connect a crankshaft 806 of the engine 106 to a rotor shaft 808 of the generator 108, which enables torque and rotational speed from the engine 106 to directly drive the generator 108.

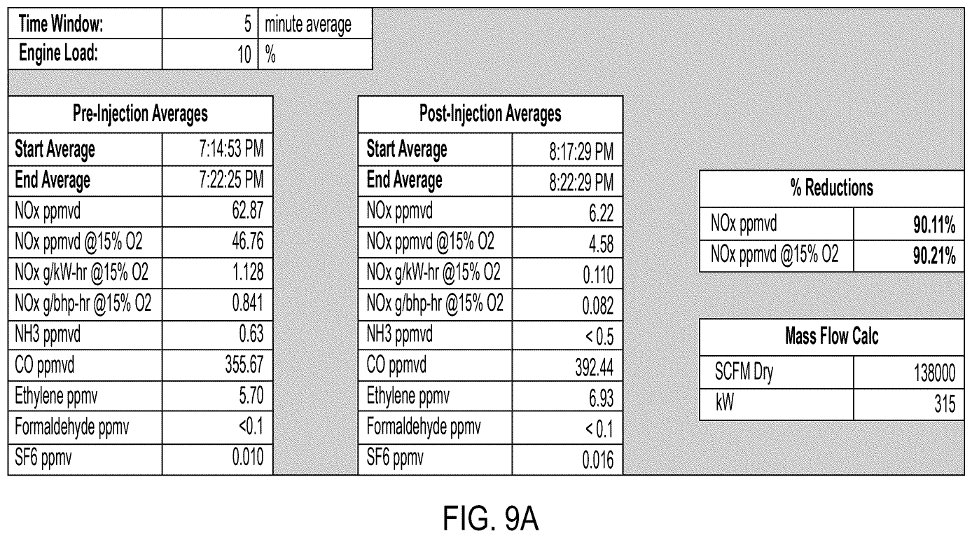

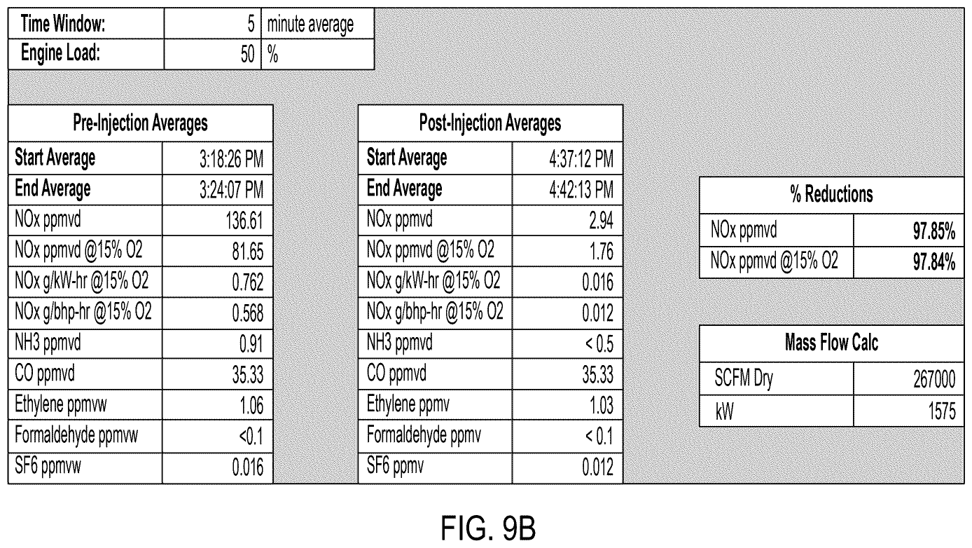

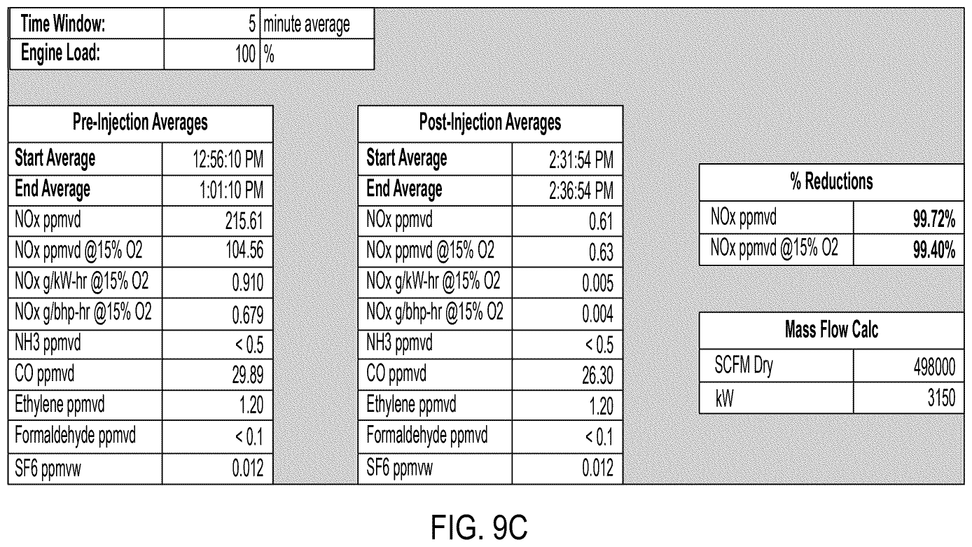

FIGS. 9A-9C present tables of pre-injection and post-injection averages of exhaust chemicals outputted from embodiments of systems discussed herein, running at 10%, 50%, and 100% engine load.

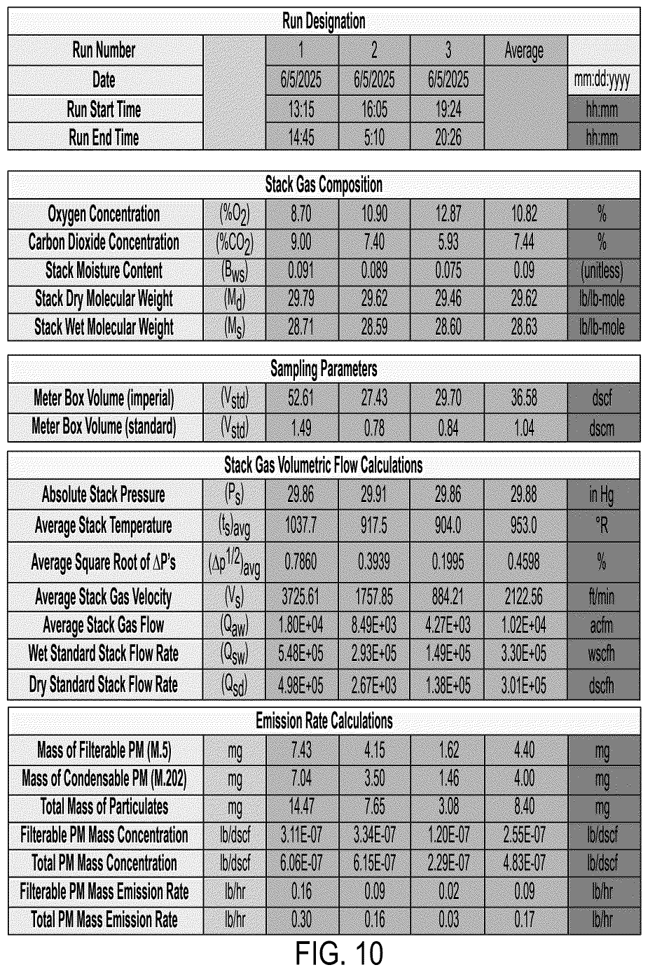

FIG. 10 presents tables of particulate matter mass concentrations and mass emission rates (both in filterable particulate matter and in total particulate matter) resulting from embodiments of systems discussed herein.

### Non-Limiting Example Embodiments

One or more embodiments of the present disclosure may further be described in view of the follow clauses associated with non-limiting example embodiments:
1. A diesel generator system comprising an engine, generator, SCR reactor, aqueous ammonia storage, injection system, and exhaust monitoring sensors to maintain exhaust temperature during ammonia injection.
2. The system of embodiment 1, wherein the aqueous ammonia mixture comprises approximately 10% ammonia and 90% water.
3. The system of any preceding embodiment, wherein control logic modulates injection rate based on temperature and NOx conversion targets to reduce ammonia slip.
4. The system of any preceding embodiment, further comprising an enclosure supporting an SCR unit and exhaust silencer.
5. The system of any preceding embodiment, integrated with switchgear and a power management system for generator plant operation.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A selective catalytic reduction (SCR) system for a diesel generator platform, comprising:
an SCR reactor comprising a catalyst and an exhaust inlet, wherein the SCR reactor is configured to receive engine exhaust gas comprising nitrogen oxides (NOx) and convert NOx to nitrogen and water in the presence of a reductant;
an injector upstream of the SCR reactor configured to meter the reductant into the exhaust gas, the reductant comprising an ammonia-based reductant;
one or more sensors comprising sensor signals of at least one of: upstream NOx, downstream NOx, catalyst temperature, exhaust temperature, exhaust flow, differential pressure, reductant flow, or reductant pressure; and
a controller coupled to the one or more sensors and the injector, wherein the controller is configured to:
enable dosing of the reductant within a temperature band based on sensor signals;
regulate an NH3/NOx ratio based on the sensor signals; and
adjust dosing of the reductant responsive to generator load signals to anticipate flow changes of the exhaust gas.

2. The SCR system of claim 1, wherein the ammonia-based reductant is an aqueous ammonia solution having a concentration of about 5-30% in water.

3. The SCR system of claim 1, wherein the injector comprises an atomizing injector supplied by a metering pump and a pressurized ammonia feed.

4. The SCR system of claim 1, further comprising:
line heaters or heat tracing, wherein the catalyst temperature is thermally controlled, at least in part, via the line heaters or heat-tracing.

5. The SCR system of claim 1, wherein the diesel generator platform comprises an electrical generator.

6. The SCR system of claim 5, wherein the diesel generator platform further comprises a diesel engine mechanically coupled to the electrical generator, wherein the diesel engine is EPA Tier 4 Final compliant.

7. The SCR system of claim 5, wherein the generator load signals comprise, at least in part, a transient load feed-forward signal proportional to real-power change of the electrical generator.

8. A power generation system, comprising:
a diesel engine;
an engine-mounted electronic control unit configured to govern the diesel engine;
an electrical generator mechanically coupled to the diesel engine;
a selective catalytic reduction (SCR) subsystem, comprising:
an SCR reactor comprising a catalyst and an exhaust inlet, wherein the SCR reactor is configured to receive exhaust gas from the diesel engine comprising nitrogen oxides (NOx) and convert NOx to nitrogen and water in the presence of a reductant;
an injector upstream of the SCR reactor configured to meter the reductant into the exhaust gas;
one or more sensors comprising sensor signals of at least one of: upstream NOx, downstream NOx, catalyst temperature, exhaust temperature, exhaust flow, differential pressure, reductant flow, or reductant pressure; and
a controller coupled to the one or more sensors and the injector, wherein the controller is configured to enable dosing of the reductant within a temperature band based on the sensor signals; and
an integrated controls and switchgear assembly that coordinates with the engine-mounted electronic control unit and the SCR subsystem.

9. The power generation system of claim 8, wherein the reductant comprises an ammonia-based reductant is an aqueous ammonia solution having a concentration of about 5-30% in water.

10. The power generation system of claim 8, wherein the injector comprises an atomizing injector supplied by a metering pump and a pressurized ammonia feed.

11. The power generation system of claim 8, further comprising:
line heaters or heat tracing, wherein the catalyst temperature is thermally controlled, at least in part, via the line heaters or heat-tracing.

12. The power generation system of claim 8, wherein the diesel engine is EPA Tier 4 Final compliant.

13. The power generation system of claim 8, wherein the controller is further configured to:
adjust dosing of the reductant responsive to generator load signals to anticipate flow changes of the exhaust gas.

14. The power generation system of claim 13, wherein the generator load signals comprise, at least in part, a transient load feed-forward signal proportional to real-power change of the electrical generator.

15. The power generation system of claim 8, wherein the controller is further configured to:
regulate an NH3/NOx ratio based on the sensor signals.

16. A method of controlling a selective catalytic reduction (SCR) system comprising an SCR reactor, a catalyst, and a reductant, the method comprising:
acquiring sensor signals comprising at least one of: upstream NOx, downstream NOx, catalyst temperature, exhaust temperature, exhaust flow, differential pressure, reductant flow, or reductant pressure;
receiving a load-related signal indicative of generator real-power or a kW-command from a generator supervisory controller;
enabling reductant dosing in a temperature band conducive to NOx conversion;
generating a dosing command for the reductant based on the sensor signals;
metering and injecting, responsive to the dosing command, the reductant into engine exhaust upstream of the catalyst to convert NOx in the SCR reactor;
controlling an NH₃/NOx ratio toward a near-stoichiometric value to achieve NOx conversion efficiency;
minimizing ammonia slip under steady-state and transient loading.

17. The method of claim 16, wherein the reductant is an aqueous ammonia solution having a concentration of about 5-30% in water.

18. The method of claim 16, further comprising:
inhibiting the injection of the reductant during start or stop sequences or upon detection of a fault condition.

19. The method of claim 16, further comprising:
driving heating elements associated with the SCR reactor to maintain a catalyst temperature within the temperature band.

20. The method of claim 16, further comprising:
detecting an ammonia leak; and
disabling dosing and isolating a reductant supply via emergency-stop logic responsive to the leak detection.
